(19) United States
(12) Patent Application Publication
(10) Pub. No.: US 2010/0239922 A1
(43) Pub. Date: Sep. 23, 2010

(54) FUEL CELL SYSTEM AND METHOD OF DRIVING THE SAME

(75) Inventors: Chi-Seung LEE, Suwon-si (KR); Jin-Hwa LEE, Suwon-si (KR); Seong-Jin AN, Suwon-si (KR); Jun-Young PARK, Suwon-si (KR); Jun-Won SUH, Suwon-si (KR)

Correspondence Address: KNOBBE MARTENS OLSON & BEAR LLP, 2040 MAIN STREET, FOURTEENTH FLOOR, IRVINE, CA, 92614, US

(73) Assignee: SAMSUNG SDI CO., LTD., Suwon-si (KR)

(21) Appl. No.: 12/638,676

(22) Filed: Dec. 15, 2009

(30) Foreign Application Priority Data
Mar. 20, 2009 (KR) 10-2009-0024090

(51) Int. Cl. H01M 8/00; H01M 8/04

(52) U.S. Cl. 429/413; 429/442; 429/468

(57) ABSTRACT

A fuel cell system and a method for driving the fuel cell system are disclosed. In one aspect, the fuel cell system may include a fuel stack, a fuel supply unit, an oxidizer supply unit, a humidifying unit, and a controller configured to measure the temperature of unit cells within the fuel cell stack and configured to detect the lowest measured temperature. The fuel cell stack may include a membrane electrode assembly and a plurality of unit cells. The membrane electrode assembly may include a membrane, a cathode disposed at a first side of the membrane and an anode disposed at a second side of the membrane. In another aspect, a method of driving a fuel cell system may include sequentially supplying a humidified fuel and an oxidizer to a fuel cell stack, measuring the temperature of each of a plurality of unit cells in the fuel cell stack, detecting to detect a unit cell having the lowest temperature among the measured temperature of each of the plurality of unit cells and decreasing humidification temperature of the fuel to be lower than the lowest temperature.

### CROSS-REFERENCE TO RELATED APPLICATIONS

This application is a non-provisional application, which claims priority to and the benefit of Korean Patent Application No. 10-2009-0024090, filed in the Korean Intellectual Property Office on Mar. 20, 2009, the entire contents of which are incorporated herein by reference.

### BACKGROUND

1. Field of the Invention

The present invention relates to a fuel cell system and a driving method thereof.

2. Description of the Related Art

A fuel cell is a device that electrochemically generates electrical power by facilitating an electrochemical reaction between a fuel (hydrogen or reformed gas) and an oxidizer (oxygen or air). Generally, pure hydrogen or a fuel containing a large amount of hydrogen that is generated by reforming a hydrocarbon-based fuel such as liquefied natural gas (LNG), liquefied petroleum gas (LPG), and CH3OH is used as the fuel and pure oxygen or air containing a large amount of oxygen is used as the oxidizer of the fuel cell.

One type of fuel cell is a polymer electrolyte membrane fuel cell (“PMFC”). The PMFC has relatively high density and relatively high energy conversion efficiency, and is operable at a relatively low temperature of 80° C. or less. In addition, the PMFC can be miniaturized and sealed and thus it has been widely used as a power source for a variety of applications such as for a pollution-free vehicle, home power equipment, mobile communication equipment, military equipment, medical equipment, and the like.

### SUMMARY OF CERTAIN INVENTIVE ASPECTS

In one aspect, a fuel cell system is provided that can be normally driven in an initial driving stage of a fuel cell stack. In another aspect a method of driving the fuel cell system is provided.

In one aspect, a method of driving method of a fuel cell system includes sequentially supplying a humidified fuel and an oxidizer to a fuel cell stack; measuring the temperature of each of a plurality of unit cells in the fuel cell stack; detecting to detect a unit cell having the lowest temperature among the measured temperature of each of the plurality of unit cells; and decreasing humidification temperature of the fuel to be lower than the lowest temperature.

In some embodiments, the sequential supplying of the humidified fuel and the oxidizer may include supplying the oxidizer between about 30 seconds and about 2 minutes after supplying the humidified fuel. In some embodiments, the method further may include connecting the fuel cell stack and to a load. In some embodiments, the connecting the fuel cell stack to the load occurs when the voltage of the fuel cell stack reaches an open circuit voltage (OCV). In some embodiments, the method further may include detecting a temperature increase speed of the unit cell having the lowest temperature by measuring the temperature of the unit cell for a unit time. In some embodiments, the method further may include increasing the humidification temperature corresponding to the temperature increase speed.

In another aspect, a method of driving method of a fuel cell system includes supplying a humidified fuel and an oxidizer to a fuel cell stack, wherein the fuel cell stack forms part of a fuel cell system; measuring the temperature of each of a plurality of unit cells of the fuel cell stack to detect a unit cell having the lowest measured temperature among the plurality of unit cells; and decreasing humidification temperature of the fuel to be lower than the lowest measured temperature.

In some embodiments, the method further includes detecting a temperature increase speed of the unit cell having the lowest temperature by repeatedly measuring the temperature of the unit cell for each over a unit time. In some embodiments, the method further includes increasing the humidification temperature corresponding to the temperature increase speed.

In another aspect, a fuel cell system includes a fuel cell stack including a membrane electrode assembly (“MEA”) and a plurality of unit cells; a fuel supply unit configured to supply a fuel to the fuel cell stack; an oxidizer supply unit configured to supply an oxidizer to the fuel cell stack; a humidifying unit configured to provide humidity to the fuel; and a controller.

In some embodiments, the controller is configured to sequentially supply controls the fuel and the oxidizer to be sequentially supplied. In some embodiments, the controller is configured to lower the humidification temperature below the lowest measured temperature. In some embodiments, the MEA has a membrane, a cathode disposed at a first side of the membrane, and an anode disposed at a second side of the membrane. In some embodiments, each unit cell of the plurality of unit cells has a separator attached to the MEA. In some embodiments, the controller is configured to detect a unit cell among the plurality of unit cells having the lowest measured temperature by measuring the temperature of each of the plurality of unit cells. In some embodiments, the controller is configured to control a humidification temperature of the humidifying unit to be lower than the lowest temperature.

In some embodiments, the fuel cell stack can be normally driven in an initial driving stage.

### BRIEF DESCRIPTION OF THE DRAWINGS

A fuel cell system and/or a method of driving a fuel cell system according to some of the described embodiments can have several aspects, no single one of which necessarily is solely responsible for the desirable attributes of the fuel cell system and/or the method of driving the fuel cell system. After considering this discussion, and particularly after reading the section entitled “Detailed Description of Certain Inventive Embodiments” one will understand how the features of this invention provide advantages that include the ability to make and use a fuel cell system and/or a method of driving a fuel cell system.

FIG. 1 is a schematic diagram of an entire configuration of a fuel cell system according to an exemplary embodiment.

FIG. 2 is a flowchart of a driving method of a fuel cell system according to a first exemplary embodiment.

FIG. 3 shows a temperature change A according to time of a unit cell having the lowest temperature among a plurality of unit cells of a fuel cell stack 50 and a humidification temperature change B of a humidifying unit 20.

FIG. 4 shows a voltage of a fuel cell stack, obtained by driving the fuel cell system according to the first exemplary embodiment.

FIG. 5 is a flowchart of a driving method of a fuel cell system according to a second exemplary embodiment.

FIG. 6 shows a voltage of a fuel cell stack, obtained by driving the fuel cell system according to the second exemplary embodiment.

### DETAILED DESCRIPTION OF CERTAIN INVENTIVE EMBODIMENTS

In the following detailed description, only certain exemplary embodiments have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

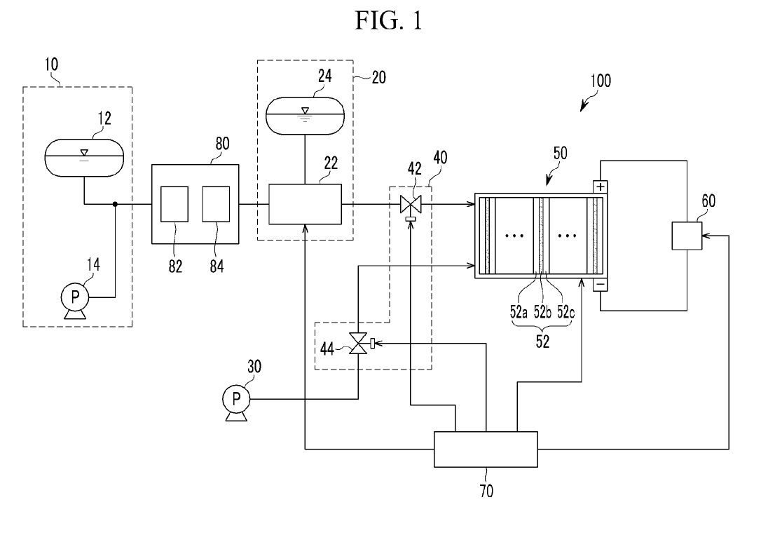

FIG. 1 is a schematic diagram of a fuel cell system 100 according to one exemplary embodiment. The fuel cell system 100 may employ a polymer electrolyte membrane fuel cell (“PEMFC”) method in which hydrogen is generated by reforming a fuel to thereby generate electrical energy through electrochemical reaction between oxygen and the hydrogen. However, the present disclosure is not limited thereto. The fuel cell system may include, for example, a hydrogen-containing liquid or a gas fuel such as methanol, ethanol, liquefied petroleum gas (“LPG”), liquefied natural gas (“LNG”), gasoline, or butane gas. As in the fuel cell system 100 of FIG. 1, a fuel cell stack 50 may be configured to perform a direct oxidation fuel cell method in which electrical energy is generated through direct reaction between liquid or gas fuel with oxygen in a unit cell.

The fuel used for the fuel cell system 100 may be liquid or gaseous carbon-hydrogen fuel, for example methanol, ethanol, natural gas or LPG. In addition, the fuel cell system 100 may use oxygen gas stored in a storage unit or air as an oxidizer that reacts with hydrogen.

The fuel cell system 100 includes a fuel supply unit 10, a humidifying unit 20, an oxidizer supply unit 30, a supply amount controller 40, the fuel cell stack 50, a load 60 and a controller 70. The fuel supply unit 10 includes a fuel tank 12 and a fuel pump 14. The fuel tank 12 is configured to store liquid or gas fuel. The fuel pump 14 is connected to the fuel tank 12 and configured to emit the fuel stored in the fuel tank 12 by using a predetermined pumping force from the fuel tank 12.

The humidifying unit 20 includes a humidifier 22 and a water supply unit 24. The humidifier 22 is in fluid communication with the fuel tank 12 and configured to humidify the fuel emitted from the fuel tank 12. A humidification temperature of the humidifier 22 may be controlled by the controller 70. The water supply unit 24 is in fluid communication with the humidifier 22 and is configured to supply water to the humidifier 22.

The oxidizer supply unit 30 is configured to supply an oxidizer to the fuel cell stack 50. The oxidizer supply unit 30 includes an oxidizer pump. The oxidizer pump is configured to aspirate external air with a predetermined pumping force. The supply amount controller 40 includes a fuel control valve 42 and an oxidizer control valve 44. The fuel control valve 42 is in fluid communication with both the humidifying unit 20 and the fuel cell stack 50. The fuel control valve 42 is configured to supply humidified fuel to the fuel cell stack 50 and is configured to be controlled by the controller 70. In the embodiment illustrated in FIG. 1, the supply of the humidified fuel may be controlled according to a degree of openness of the fuel control valve 42.

The oxidizer control valve 44 is in fluid communication with both the oxidizer supply unit 30 and the fuel cell stack 50. The oxidizer control valve 44 is configured to supply the oxidizer to the fuel cell stack 50 and is configured to be controlled by the controller 70. Here, the oxidizer supply is controlled according to a degree of openness of the oxidizer control valve 44.

The fuel cell stack 50 may include a plurality of unit cells that generate electrical energy by facilitating and/or inducing an oxidation/reduction reaction between the fuel and the oxidizer. As one of the plurality of unit cells, a unit cell 52 includes a membrane electrode assembly (“MEA”) 52b that oxidizes/reduces oxygen among the fuel and the oxidizer and separators (also referred to as bipolar plates) 52a and 52c for supplying the fuel and the oxidizer to the MEA 52b. The unit cell 52 has a structure in which the separators 52a and 52c are arranged, interposing the MEA 52b therebetween. The MEA 52b includes a membrane disposed in the center thereof, a cathode disposed at a first side of the membrane, and an anode disposed at a second side of the membrane. The cathode is supplied with the oxidizer and the anode is supplied with the fuel through the separators 52a and 52c. The fuel cell system 100 includes the fuel cell stack 50 with unit cells 52 arranged in series.

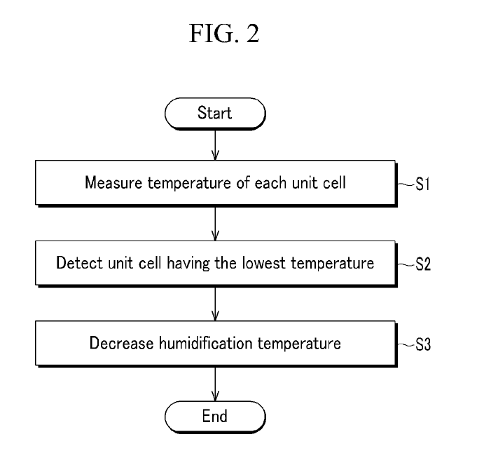

If the fuel cell stack 50 has not been driven for a long period of time or if the fuel cell stack 50 is relatively cold, the MEA 52b is in a “dried” state. Accordingly, conductivity of protons is decreased in an initial driving stage of the fuel cell stack 50. To prevent this, water may be included in the fuel when supplying the fuel to the fuel cell stack 50. However, when the temperature of the water is higher than the internal temperature of the fuel cell stack 50, the water condenses in the fuel cell stack 50. In particular, the water condensation may occur within a portion of the fuel cell stack 50 where a unit cell having the lowest temperature is located. In this case, the condensed water blocks the path of the fuel and the oxidizer so that the output voltage of the fuel cell stack 50 in the initial driving state is significantly reduced. Therefore, the temperature of the water included in the fuel should be controlled. To avoid a reduction in output voltage of the fuel cell stack 50 during the initial driving state, the temperature of each of a plurality of unit cells that form a fuel cell stack 50 is measured to detect a unit cell having the lowest temperature. Then the water temperature is controlled to be lower than the lowest temperature of the fuel cell stack 50 by controlling the humidifying unit 20. This process will be described in further detail below with reference to FIG. 2.

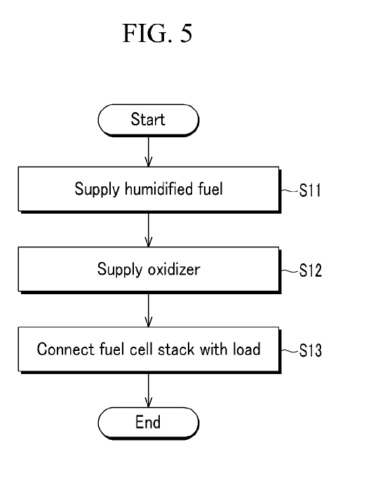

In general, a fuel and an oxidizer are simultaneously supplied to the fuel cell stack 50. However, when the MEA 52b is in the dried state and even though the fuel contains water, the output voltage of the fuel cell stack 50 may be significantly reduced in the initial driving stage if water supply is insufficient. To prevent this, a fuel containing water may be supplied prior to supplying oxidizer according to a second exemplary embodiment of the present disclosure. This will be described in further detail below with reference to FIG. 5.

In addition, the load 60 is electrically connected to a positive (+) terminal and a negative (−) terminal of the fuel cell stack 50, and consumes electrical energy generated from the fuel cell stack 50. The load 60 may be include various electrical devices such as a motor of a vehicle, an inverter that converts direct-current electricity to alternating-current electricity and/or an electrical heating device. The controller 70 may be configured to control operation of each of the humidifying unit 20, the supply amount controller 40, the fuel cell stack 50 and the load 60. In further detail, when the fuel cell system 100 is first being driven, the controller 70 may control the fuel control valve 42 to open first and then the oxidizer control valve 44 to open after a predetermined time has passed. In addition, the controller 70 may measure the temperature of each of the plurality of unit cells when the fuel cell system 100 is first driven. The controller 70 may be configured to detect a unit cell having the lowest temperature among the plurality of unit cells and may be configured to control the humidification temperature of the humidifying unit 20 to be lower than the detected temperature of the unit cell.

The fuel cell system 100 further includes a reformer 80. The reformer 80 is configured to generate a reformed gas using fuel between the fuel supply unit 10 and the humidifying unit 20. The reformer 80 may be configured to change liquid fuel to hydrogen gas for electricity generation of the fuel cell stack 50 through a reforming reaction. The reformer 80 may be configured to decrease concentration of carbon monoxide included in the hydrogen gas. In general, the reformer 80 includes a reforming unit 82 that generates hydrogen gas by reforming the liquid fuel and a carbon monoxide decreasing unit 84 configured to decrease concentration of the carbon monoxide in the hydrogen gas. The reforming unit 82 is configured to change the fuel to a reformed gas containing sufficient hydrogen through a catalytic reaction such as steam reforming, partial oxidation, and an exothermic reaction. In addition, the carbon monoxide decreasing unit 84 may be configured to decrease concentration of the carbon monoxide contained in the reformed gas using a catalytic reaction such as a water-gas shift reaction and selective oxidation, or hydrogen purification using a membrane. Although the reformer 80 in FIG. 1 is formed separate from the humidifying unit 20, the reformer 80 may include the humidifying unit 20.

FIG. 2 is a flowchart of method of driving a fuel cell system. Referring to FIG. 2, the controller 70 controls the temperature of the humidifying unit 20 to be within a predetermined range before the fuel and the oxidizer may be supplied to the fuel cell stack 50. In this case, the temperature of the humidifying unit 20 is set to be lower than the temperature of the fuel cell stack 50 in consideration of the temperature of the fuel cell stack 50 in the driven state. Water heated to the predetermined temperature is mixed with the fuel and the subsequent mixture is supplied to the fuel cell stack 50. Here, the oxidizer is starting to be supplied to the fuel cell stack 50. Then, the temperature of the fuel cell stack 50 is gradually increased by reaction between the fuel and the oxidizer. In this case, the internal temperature of the fuel cell stack 50 is not uniform. That is, a temperature difference exists according to locations of the respective unit cells. Next, the controller 70 measures the temperature of each of the plurality of unit cells (S1). Subsequently, the controller 70 detects a unit cell having the lowest temperature among the plurality of unit cells (S2). Here, the controller 70 measures the temperature of the corresponding unit cell for each unit time to detect a temperature increase speed. Then, the controller 70 controls the temperature of the humidifying unit 20 to be lower than the temperature of the corresponding unit cell (S3). In this case, the controller 70 controls the temperature of the humidifying unit 20 to be increased corresponding to the temperature increase speed of the corresponding unit cell. Accordingly, when humidified fuel enters into the fuel cell stack 50, water condensation at a location of the unit cell having the lowest temperature among the plurality of unit cells can be prevented.

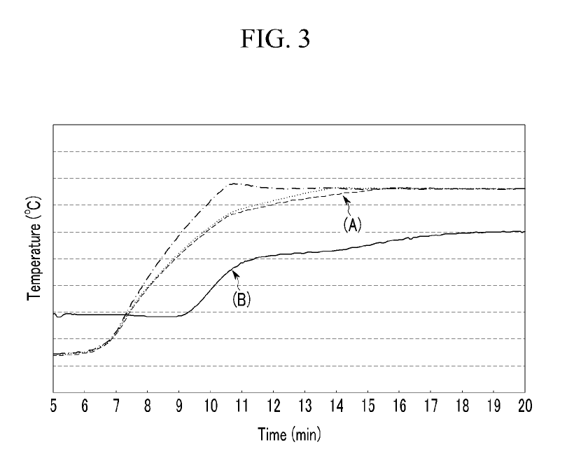

FIG. 3 shows a temperature change “A” according to time of the unit cell having the lowest temperature among the plurality of unit cells, and a humidification temperature change “B” of the humidifying unit 20 of the fuel cell stack 50. As shown in FIG. 3, the temperature of the unit cell having the lowest temperature is lower than the humidification temperature of the humidifying unit 20. In this case, the humidification temperature of the humidifying unit 20 is higher than the temperature of the unit cell having the lowest temperature during a predetermined time period in the initial driving stage. However, the water supplied during the predetermined time period is absorbed by the MEA 52b of the corresponding unit cell so that water condensation does not occur. Thus, blocking of the fuel path due to condensation of the humidified fuel in the fuel cell stack 50 can be prevented.

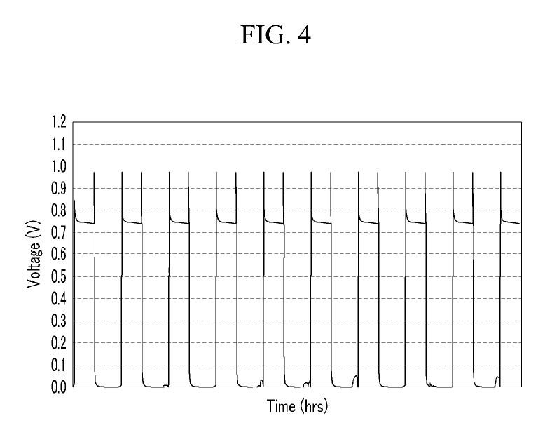

FIG. 4 is a graph showing a voltage of the fuel cell stack, obtained by driving the fuel cell system according to the first exemplary embodiment illustrated in FIG. 1. The graph shows a result obtained by driving the fuel cell stack 50 10 times. As shown in FIG. 4, according to the driving method of the fuel cell system of the first exemplary embodiment, a sudden voltage drop due to the water condensation does not occur.

FIG. 5 is a flowchart of a driving method of the fuel cell system according to a second exemplary embodiment. As shown in FIG. 5, the controller 70 opens the fuel control valve 42 and supplies humidified fuel to the fuel cell stack 50 (S11). In this case, the oxidizer control valve 44 is maintained in the closed state. That is, the fuel cell stack 50 starts to be driven in a state in which the humidified fuel is supplied in advance thereto and the MEA 52b absorbs water. Next, the controller 70 opens the oxidizer control valve 44 to supply an oxidizer when the humidified fuel is supplied to the fuel cell stack 50 for a predetermined time period (S12). Here, the oxidizer control valve 44 is opened after about 30 seconds to about 2 minutes after opening the fuel control valve 42. However, methods and systems of the present disclosure are not limited thereto. For example, the opening time of the oxidizer control valve 44 may be changed according to parts of the fuel cell stack 50, a driving condition of the fuel cell stack 50 and/or the amount of fuel supplied to the fuel cell stack 50. When the oxidizer control valve 44 is opened and the predetermined time has passed, the controller 70 may connect the fuel cell stack 50 with a load 60 (S13). In this case, a connection time of the fuel cell stack 50 and the load 60 is a time at which the voltage of the fuel cell stack 50 reaches an open circuit voltage (“OCV”). For example, the fuel cell stack 50 and the load 60 are connected 10 to 20 seconds after the opening of the oxidizer control valve 44.

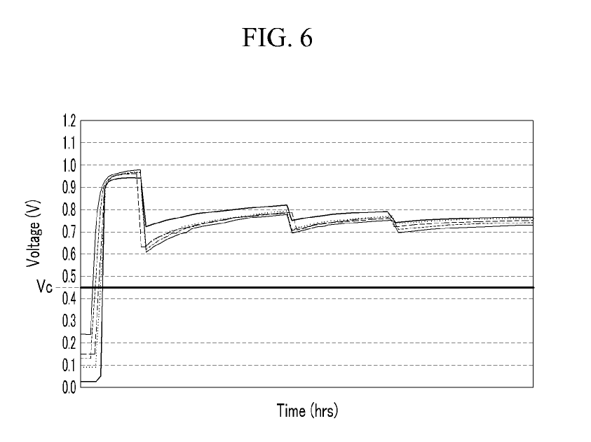

FIG. 6 is a graph showing a voltage of the fuel cell stack, obtained by driving the fuel cell system according to the second exemplary embodiment of. The graph shows a result obtained by driving the fuel cell stack 50 5 times. As shown in FIG. 6, according to the driving method of the fuel cell system of the second exemplary embodiment, the voltage of the fuel cell stack 50 may not be decreased lower than a reference voltage Vc. Here, the reference voltage Vc is a voltage that determines a failure of the fuel cell stack 50. Therefore, the fuel cell stack 50 is normally driven in an initial driving stage.

In addition, the second exemplary embodiment may include the structure of the first exemplary embodiment in which the unit cell having the lowest temperature and humidification temperature is controlled to be lower than the temperature of the detected unit.

The foregoing description details certain embodiments of the invention. It will be appreciated, however, that no matter how detailed the foregoing appears in the text, the invention can be practiced in additional ways. It should also be noted that the use of particular terminology when describing certain features or aspects of the invention should not be taken to imply that the terminology is being re-defined herein to be restricted to include any specific characteristics of the features or aspects of the invention with which that terminology is associated. Further, numerous applications are possible for devices of the present disclosure. It will be appreciated by those skilled in the art that various modifications and changes may be made without departing from the scope of the invention. Such modifications and changes are intended to fall within the spirit and scope of the invention, as defined by the appended claims.

What is claimed is:

1. A method of driving a fuel cell system, the method comprising:
sequentially supplying a humidified fuel and an oxidizer to a fuel cell stack;
measuring the temperature of each of a plurality of unit cells in the fuel cell stack;
detecting a unit cell having the lowest temperature among the measured temperature of each of the plurality of unit cells; and
decreasing humidification temperature of the fuel to be lower than the lowest temperature.

2. The method of driving a fuel cell system according to claim 1, wherein the sequential supplying of the humidified fuel and the oxidizer comprises supplying the oxidizer between about 30 seconds and about 2 minutes after supplying the humidified fuel.

3. The method of driving a fuel cell system according to claim 1 further comprising connecting the fuel cell stack to a load.

4. The method of driving a fuel cell system according to claim 3, wherein the connecting the fuel cell stack to the load occurs when voltage of the fuel cell stack reaches an open circuit voltage.

5. The method of driving a fuel cell system according to claim 1 further comprising detecting a temperature increase speed of the unit cell having the lowest temperature by measuring the temperature of the unit cell for a unit time.

6. The method of driving a fuel cell system according to 5 further comprising increasing the humidification temperature corresponding to the temperature increase speed.

7. A method of driving a fuel cell system, the method comprising:
supplying a humidified fuel and an oxidizer to a fuel cell stack, wherein the fuel cell stack forms part of a fuel cell system;
measuring the temperature of each of a plurality of unit cells of the fuel cell stack to detect a unit cell having the lowest measured temperature among the plurality of unit cells; and
decreasing humidification temperature of the fuel to be lower than the lowest measured temperature.

8. The method of driving a fuel cell system according to claim 7, further comprising detecting a temperature increase speed of the unit cell having the lowest temperature by repeatedly measuring the temperature of the unit cell over a unit time.

9. The method of driving a fuel cell system of claim 8 further comprising increasing the humidification temperature corresponding to the temperature increase speed.

10. A fuel cell system, comprising:
a fuel cell stack including a membrane electrode assembly (“MEA”) and a plurality of unit cells, the MEA having a membrane, a cathode disposed at a first side of the membrane and an anode disposed at a second side of the membrane, each unit cell of the plurality of unit cells has a separator attached to the MEA;
a fuel supply unit configured to supply a fuel to the fuel cell stack;
an oxidizer supply unit configured to supply an oxidizer to the fuel cell stack;
a humidifying unit configured to provide humidity to the fuel; and
a controller configured to detect a unit cell among the plurality of unit cells having the lowest measured temperature and configured to control a humidification temperature.

11. The fuel cell system according to claim 10, wherein the controller is configured to sequentially supply the fuel and the oxidizer.

12. The fuel cell system according to claim 10, wherein the controller is configured to lower the humidification temperature below the lowest measured temperature.
